(19) United States
(12) Patent Application Publication
(10) Pub. No.: US 2023/0050071 A1
(43) Pub. Date: Feb. 16, 2023

(54) WORK MACHINE AND REMOTE CONTROL SYSTEM FOR WORK MACHINE

(71) Applicant: Komatsu Ltd., Tokyo (JP)

(72) Inventors: Jun Morinaga, Tokyo (JP); Yasuhiro Ibusuki, Tokyo (JP); Atsuhito Kawahara, Tokyo (JP); Masanori Minagawa, Tokyo (JP)

(73) Assignee: Komatsu Ltd., Tokyo (JP)

(21) Appl. No.: 17/785,720

(22) PCT Filed: Jan. 26, 2021
(86) PCT No.: PCT/JP2021/002613

§ 371 Date: Jun. 15, 2022

(30) Foreign Application Priority Data
Feb. 21, 2020 (JP) 2020-028618

(51) Int. Cl. E02F 9/26; H04N 5/247; H04N 7/18; H04N 5/265

(52) U.S. Cl. CPC E02F 9/26; H04N 5/247; H04N 7/181; H04N 5/265; E02F 3/308

(57) ABSTRACT

A work machine includes: a vehicle body; a first imaging device that is disposed in the vehicle body and images a first imaging range; a second imaging device that is disposed in the vehicle body and images a second imaging range; and a communication device that transmits a first image in the first imaging range and a second image in the second imaging range to a remote place. At least a part of the second imaging range is set below the first imaging range.

### FIELD

The present disclosure relates to a work machine and a remote operation system for the work machine.

### BACKGROUND

In a technical field related to work machines, a technique for remotely operating a work machine is known. In the remote operation of the work machine, an image of a work site where the work machine operates is captured by an imaging device. The image captured by the imaging device is displayed on a display device disposed at a remote place. The operator at the remote place remotely operates the work machine while viewing the image displayed on the display device. Patent Literature 1 discloses a technique in which an imaging device is disposed in a driver's cab on a swing body and captures an image in front of the driver's cab.

### CITATION LIST

### Patent Literature

Patent Literature 1: JP 2019-068236 A

### SUMMARY

### Technical Problem

An operator at the remote place may want to visually recognize not only the situation in front of the driver's cab but also the situation on a front lower side of the driver's cab. In a case where the imaging device captures only an image in front of the driver's cab, it may be difficult for the operator at the remote place to visually recognize the situation on a front lower side of the driver's cab.

An object of the present disclosure is to allow an operator at a remote place to visually recognize a situation on a front lower side of a driver's cab.

### Solution to Problem

According to an aspect of the present invention, a work machine comprises: a vehicle body; a first imaging device that is disposed in the vehicle body and images a first imaging range; a second imaging device that is disposed in the vehicle body and images a second imaging range; and a communication device that transmits a first image in the first imaging range and a second image in the second imaging range to a remote place, wherein at least a part of the second imaging range is set below the first imaging range.

### ADVANTAGEOUS EFFECTS OF INVENTION

According to the present disclosure, an operator at a remote place can visually recognize a situation on a front lower side of a driver's cab.

### BRIEF DESCRIPTION OF DRAWINGS

FIG. 1 is a schematic diagram illustrating a remote operation system for a work machine according to an embodiment.

FIG. 2 is a perspective view illustrating the work machine according to the embodiment.

FIG. 3 is a side view illustrating the work machine according to the embodiment.

FIG. 4 is a plan view illustrating the work machine according to the embodiment.

FIG. 5 is a diagram illustrating a remote operation room according to the embodiment.

FIG. 6 is a functional block diagram illustrating the remote operation system for the work machine according to the embodiment.

FIG. 7 is a diagram for describing processing of a first image processing unit according to the embodiment.

FIG. 8 is a diagram for describing processing of a second image processing unit according to the embodiment.

FIG. 9 is a diagram for describing processing of a display control unit according to the embodiment.

FIG. 10 is a flowchart illustrating a remote operation method of the work machine according to the embodiment.

FIG. 11 is a block diagram illustrating a computer system according to the embodiment.

### DESCRIPTION OF EMBODIMENTS

Hereinafter, embodiments according to the present disclosure will be described with reference to the drawings, but the present disclosure is not limited thereto. The components of the embodiments described below can be appropriately combined. In addition, some components may not be used.

In the embodiments, the positional relationship of each part will be described using terms of “left”, “right”, “front”, “rear”, “upper”, and “lower”. These terms indicate relative positions or directions with respect to the center of a swing body 3 of a work machine 1.

### Remote Operation System

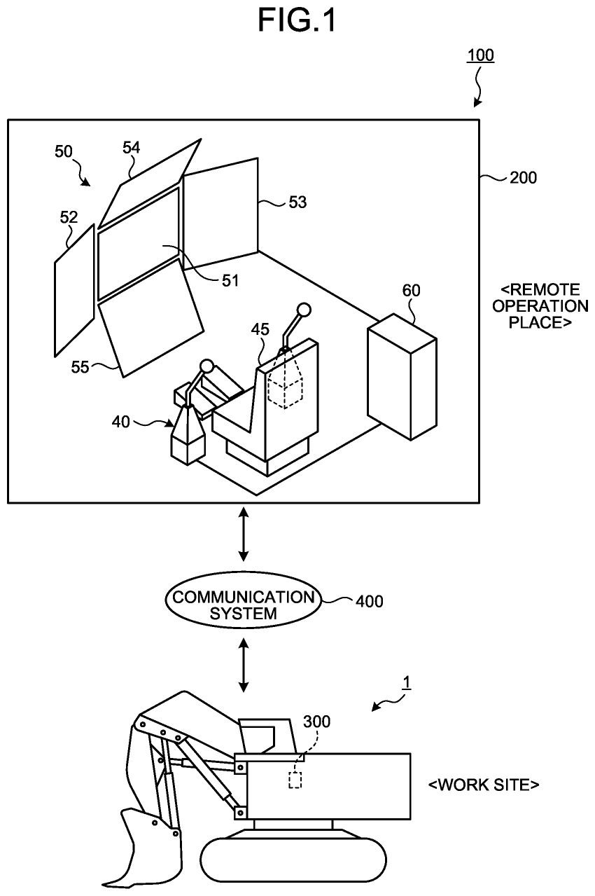

FIG. 1 is a schematic diagram illustrating a remote operation system 100 for a work machine 1 according to an embodiment. The remote operation system 100 remotely operates the work machine 1 operating at the work site. Examples of the work site include a mine or a quarry.

At least a part of the remote operation system 100 is disposed in a remote operation room 200. The remote operation room 200 is built at a remote place away from the work site. The remote operation system 100 includes a remote operation device 40, a display device 50, and a control device 60.

The remote operation device 40 is disposed in the remote operation room 200. The remote operation device 40 is operated by an operator in the remote operation room 200. The operator can operate the remote operation device 40 while seated on an operation seat 45.

The display device 50 is disposed in the remote operation room 200. The display device 50 displays an image of the work site. The operator in the remote operation room 200 cannot directly visually recognize the situation of the work site. The operator in the remote operation room 200 can visually recognize the situation of the work site via the display device 50.

The operator operates the remote operation device 40 while viewing the image of the work site displayed on the display device 50. The work machine 1 is remotely operated by the remote operation device 40.

The control device 60 is disposed in the remote operation room 200. The control device 60 includes a computer system.

The work machine 1 includes a control device 300. The control device 300 includes a computer system.

The control device 60 and the control device 300 communicate with each other via a communication system 400. Examples of the communication system 400 include the Internet, a local area network (LAN), a mobile phone communication network, and a satellite communication network. The communication system 400 may include a relay station that relays data to be communicated.

### Work Machine

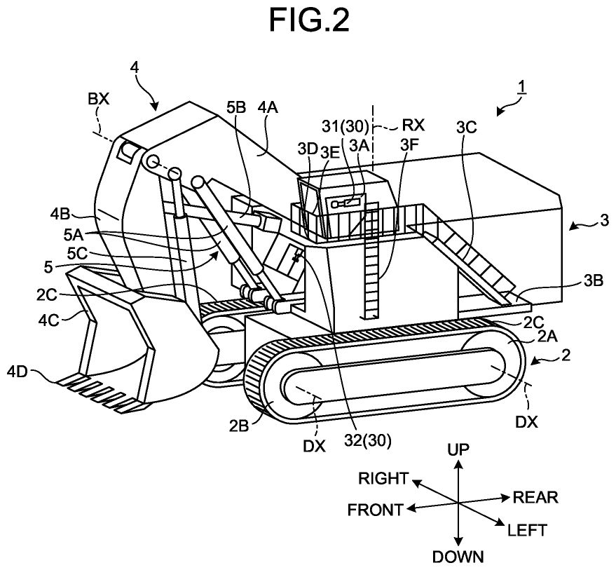

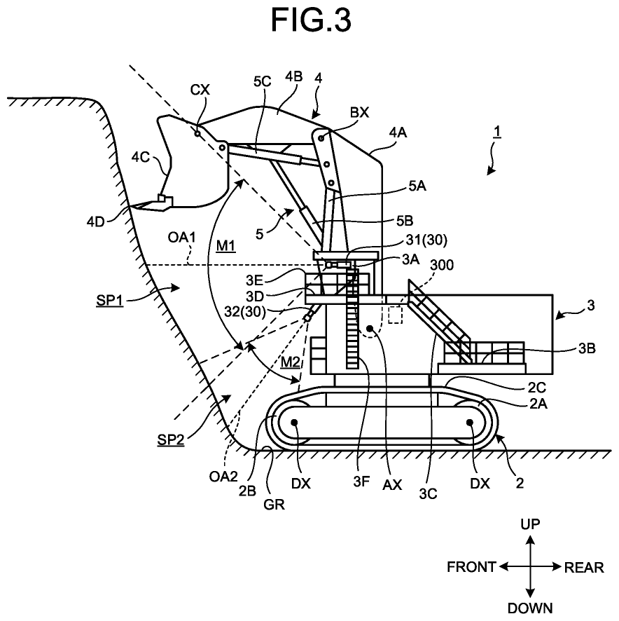

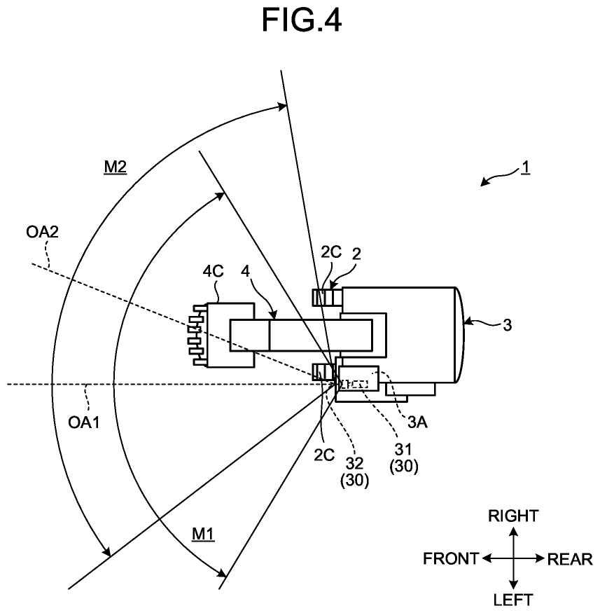

FIG. 2 is a perspective view illustrating the work machine 1 according to the embodiment. FIG. 3 is a side view illustrating the work machine 1 according to the embodiment. FIG. 4 is a plan view illustrating the work machine 1 according to the embodiment. In the embodiment, it is assumed that the work machine 1 is an excavator which is a type of loading machine. The work machine 1 operates at the work site. The work machine 1 performs excavation work of a work target. Examples of the work target include earth and sand or ore. In addition, a dump truck, which is a type of a haulage vehicle, operates at the work site. The work machine 1 performs loading work of loading a load onto the dump truck. As the load, an excavated object excavated by the excavation work is exemplified.

As illustrated in FIGS. 2, 3, and 4, the work machine 1 includes a traveling body 2, a swing body 3 supported by the traveling body 2, working equipment 4 attached to the swing body 3, a hydraulic cylinder 5 that drives the working equipment 4, and an imaging device 30.

The traveling body 2 travels while supporting the swing body 3. The swing body 3 is a vehicle body of the work machine 1. The traveling body 2 is disposed below the swing body 3. The traveling body 2 supports the swing body 3 in a swingable manner. The traveling body 2 includes a drive wheel 2A, a driven wheel 2B, and a crawler belt 2C supported by the drive wheel 2A and the driven wheel 2B. Each of the drive wheel 2A and the driven wheel 2B rotates about the rotation axis DX. A pair of drive wheels 2A, a pair of driven wheels 2B, and a pair of crawler belts 2C are provided. The crawler belt 2C is rotated by the rotation of the drive wheel 2A. When the crawler belt 2C rotates, the traveling body 2 travels.

The swing body 3 is swingable about the swing axis RX while being supported by the traveling body 2. The swing axis RX extends in the vertical direction. The swing body 3 includes a driver's cab 3A, a lower deck 3B, steps 3C, and an upper deck 3D. The driver's cab 3A is an internal space of the swing body 3 on which an operator can board. The driver's cab 3A is disposed at a front portion and an upper portion of the swing body 3. The lower deck 3B is disposed at a rear portion and a lower portion of the swing body 3. The upper deck 3D is disposed at a front portion and an upper portion of the swing body 3. The steps 3C connect the lower deck 3B and the upper deck 3D. The upper deck 3D is disposed so as to surround the driver's cab 3A. At least a part of the upper deck 3D is disposed in front of the driver's cab 3A. A palisade handrail 3E is disposed on each of the lower deck 3B, the steps 3C, and the upper deck 3D.

Each of the lower deck 3B, the steps 3C, and the upper deck 3D includes a passage through which an operator can pass. The operator can board the driver's cab 3A by passing through the lower deck 3B, the steps 3C, and the upper deck 3D.

In addition, the swing body 3 includes a ladder 3F. The ladder 3F is connected to the upper deck 3D.

The working equipment 4 is attached to the front portion of the swing body 3. The working equipment 4 is disposed in front of the swing axis RX. The working equipment 4 is operable to extend forward. The working equipment 4 includes a boom 4A connected to the swing body 3, an arm 4B connected to the boom 4A, and a bucket 4C connected to the arm 4B. The proximal end portion of the boom 4A is connected to the front portion of the swing body 3 via a pin. The proximal end portion of the arm 4B is connected to the distal end portion of the boom 4A via a pin. The proximal end portion of the bucket 4C is connected to the distal end portion of the arm 4B via a pin. The bucket 4C has a tip blade 4D. The bucket 4C excavates the work target.

The boom 4A is connected to the front portion of the swing body 3 so as to be rotatable about the boom rotation axis AX. The arm 4B is connected to the boom 4A so as to be rotatable about the arm rotation axis BX. The bucket 4C is connected to the arm 4B so as to be rotatable about the bucket rotation axis CX.

The boom rotation axis AX, the arm rotation axis BX, and the bucket rotation axis CX are parallel. Each of the boom rotation axis AX, the arm rotation axis BX, and the bucket rotation axis CX extends in the vehicle width direction of the swing body 3.

In the embodiment, the work machine 1 is a loading excavator. The loading excavator refers to an excavator in which the bucket 4C is attached to the arm 4B such that the tip blade 4D of the bucket 4C faces forward.

The hydraulic cylinder 5 includes a boom cylinder 5A that drives the boom 4A, an arm cylinder 5B that drives the arm 4B, and a bucket cylinder 5C that drives the bucket 4C. The proximal end portion of the boom cylinder 5A is connected to the swing body 3. The distal end portion of the boom cylinder 5A is connected to the boom 4A. The proximal end portion of the arm cylinder 5B is connected to the boom 4A. The distal end portion of the arm cylinder 5B is connected to the arm 4B. The proximal end portion of the bucket cylinder 5C is connected to the boom 4A. The distal end portion of the bucket cylinder 5C is connected to the bucket 4C.

### Imaging Device

The imaging device 30 images the work site and acquires an image of the work site. The imaging device 30 is disposed on the swing body 3.

Examples of the image of the work site acquired by the imaging device 30 include an image of the work target of the work machine 1, an image of at least a part of the work machine 1, an image of a structure existing in the work site, an image of a work machine different from the work machine 1, and an image of an operator working in the work site. In the embodiment, the image of the work target of the work machine 1 includes an image of the excavation target of the working equipment 4.

The imaging device 30 includes an optical system and an image sensor that receives light passing through the optical system. The image sensor includes a couple charged device (CCD) image sensor or a complementary metal oxide semiconductor (CMOS) image sensor.

In the embodiment, the imaging device 30 includes a first imaging device 31 that is disposed on the swing body 3 and images a first imaging range M1, and a second imaging device 32 that is disposed on the swing body 3 and images a second imaging range M2. Each of the first imaging device 31 and the second imaging device 32 is fixed to the swing body 3. The relative position between the first imaging device 31 and the second imaging device 32 is fixed. The second imaging device 32 images the second imaging range M2 in parallel with the imaging of the first imaging range M1 by the first imaging device 31.

In the vertical direction of the swing body 3, the second imaging device 32 is disposed below the first imaging device 31. That is, in the vertical direction of the swing body 3, the incident surface of the optical system of the second imaging device 32 is disposed below the incident surface of the optical system of the first imaging device 31.

In the left-right direction of the swing body 3, the first imaging device 31 is disposed at the same position as the second imaging device 32. The left-right direction of the swing body 3 corresponds to the vehicle width direction of the swing body 3. That is, in the left-right direction of the swing body 3, the incident surface of the optical system of the first imaging device 31 is disposed at the same position as the incident surface of the optical system of the second imaging device 32.

In the front-rear direction of the swing body 3, the first imaging device 31 is disposed behind the second imaging device 32. That is, in the front-rear direction of the swing body 3, the incident surface of the optical system of the first imaging device 31 is disposed behind the incident surface of the optical system of the second imaging device 32.

In the embodiment, the vertical direction is a direction parallel to the swing axis RX. The left-right direction is a direction parallel to the boom rotation axis AX. The front-rear direction is a direction orthogonal to both the boom rotation axis AX and the swing axis RX. A direction in which the swing body 3 exists with reference to the ground contact surface of the traveling body 2 is an upward direction, and a direction opposite to the upward direction is a downward direction. One of the left-right directions with reference to the swing axis RX is the right, and the opposite direction of the right is the left. The direction in which the working equipment 4 exists with reference to the swing axis RX is the front, and the opposite direction of the front is the rear.

The first imaging device 31 images the front of the swing body 3. The first imaging range M1 is set in front of the swing body 3. The second imaging device 32 images the front of the swing body 3. The second imaging range M2 is set in front of the swing body 3. As illustrated in FIG. 3, at least a part of the second imaging range M2 is set below the first imaging range M1. In the embodiment, the second imaging range M2 is set on the front lower side of the swing body 3. As illustrated in FIG. 4, at least a part of the second imaging range M2 is set to the right of the first imaging range M1.

The first imaging range M1 includes a front space SP1 of the swing body 3. The front space SP1 includes a space in front of the driver's cab 3A, a space obliquely above the front side of the driver's cab 3A, a space obliquely below the front side, a space obliquely left on the front side, and a space obliquely right on the front side.

The second imaging range M2 includes a front lower space SP2 below the front space SP1. The front lower space SP2 is a space below the front side of the driver's cab 3A. The front lower space SP2 includes a space in front of the traveling body 2. In addition, the front lower space SP2 includes a space on the right side of the front space SP1.

The second imaging range M2 is set such that an image suitable for excavation work by the work machine 1 can be obtained. The second imaging range M2 is set to include, for example, an excavation target such as ground or cliff from the lower side (foot) in front of the swing body 3. In addition, the second imaging range M2 is set to include, for example, the bucket 4C for performing excavation work. Note that the second imaging range M2 may be set to include a space in front of the driver's cab 3A and at substantially the same height as the driver's cab 3A in the vertical direction. Note that the second imaging range M2 may be set to include a space in front of the driver's cab 3A and above the driver's cab 3A in the vertical direction.

The first imaging device 31 is disposed inside the driver's cab 3A. In the embodiment, the first imaging device 31 is disposed on the front portion and the upper portion of the driver's cab 3A. The first imaging device 31 images the front space SP1 of the swing body 3 via the windshield of the driver's cab 3A. Note that the first imaging device 31 may be disposed behind the driver's cab 3A or may be disposed below the driver's cab 3A.

The second imaging device 32 is disposed on the upper deck 3D of the swing body 3. At least a part of the upper deck 3D is disposed in front of the driver's cab 3A. The second imaging device 32 is disposed on the lower surface of the upper deck 3D in front of the swing body 3.

The first imaging device 31 is disposed in the driver's cab 3A such that the optical axis OA1 of the optical system of the first imaging device 31 extends in the front-rear direction. The second imaging device 32 is disposed on the lower surface of the upper deck 3D such that the optical axis OA2 of the optical system of the second imaging device 32 is inclined downward toward the front. In addition, as illustrated in FIG. 4, the second imaging device 32 is disposed on the lower surface of the upper deck 3D such that the optical axis OA2 of the optical system of the second imaging device 32 is inclined rightward toward the front.

At least a part of the working equipment 4 is included in the first imaging range M1. That is, the first imaging range M1 is set to include at least a part of the working equipment 4. The bucket 4C of the working equipment 4 moves in the vertical direction within a predetermined movable range. The first imaging range M1 is set to include the bucket 4C that moves in the vertical direction.

In addition, at least a part of the work target of the work machine 1 is included in the first imaging range M1. The first imaging range M1 is set to include at least a part of the work target of the work machine 1.

At least a part of the traveling body 2 is movable to the second imaging range M2. That is, the second imaging range M2 is set so as to be able to include at least a part of the traveling body 2. When the swing body 3 swings such that the rotation axis DX of the traveling body 2 and the boom rotation axis AX become parallel to each other, the second imaging range M2 is set to include a front portion of the crawler belt 2C of the traveling body 2. Note that the traveling body 2 may not be included in the second imaging range M2 depending on, for example, the swing angle of the swing body 3.

In addition, the second imaging range M2 is set to include the bucket 4C of the working equipment 4 that has moved downward. As described above, the bucket 4C moves in the vertical direction within the predetermined movable range. The second imaging range M2 is set to include the bucket 4C moved to the lower portion of the movable range.

In addition, the second imaging range M2 is set to include at least a part of the work target of the work machine 1.

In addition, the second imaging range M2 is set to include the ground GR on which the traveling body 2 travels.

In the embodiment, the first imaging range M1 and at least a part of the second imaging range M2 overlap. As illustrated in FIG. 3, the lower portion of the first imaging range M1 and the upper portion of the second imaging range M2 overlap. As illustrated in FIG. 4, the right portion of the first imaging range M1 and the left portion of the second imaging range M2 overlap.

In the following description, an image in the first imaging range M1 captured by the first imaging device 31 will be appropriately referred to as a first image P1, and an image in the second imaging range M2 captured by the second imaging device 32 will be appropriately referred to as a second image P2.

### Remote Operation Room

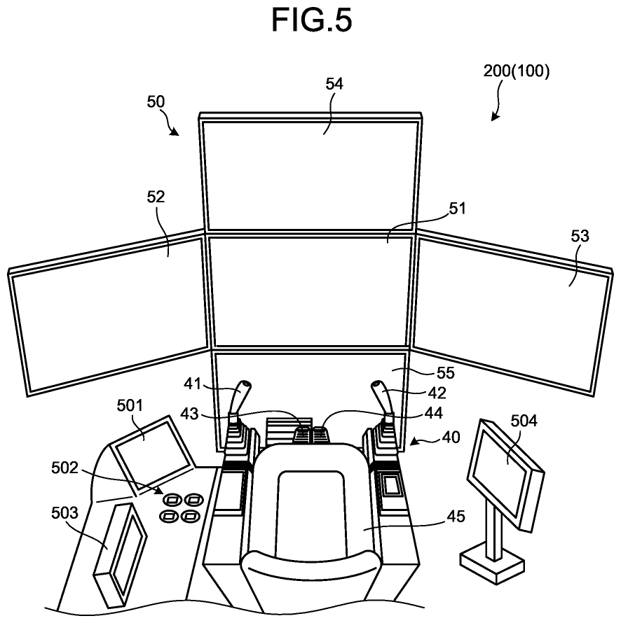

FIG. 5 is a diagram illustrating the remote operation room 200 according to the embodiment. As illustrated in FIG. 5, the remote operation device 40 and the display device 50 are disposed in the remote operation room 200.

The remote operation device 40 is operated by an operator seated on the operation seat 45. The operator sits on the operation seat 45 so as to face the display screen of the display device 50. The operator operates the remote operation device 40 while viewing the display screen of the display device 50.

An operation signal generated by operating the remote operation device 40 is transmitted to the control device 300 of the work machine 1 via the control device 60 and the communication system 400. The control device 300 operates the work machine 1 based on the operation signal acquired via the communication system 400. The operation of the work machine 1 includes at least one of the operation of the traveling body 2, the operation of the swing body 3, and the operation of the working equipment 4.

The operation of the traveling body 2 includes a forward operation and a backward operation of the traveling body 2. The operation of the swing body 3 includes a left swing operation and a right swing operation of the swing body 3. The operation of the working equipment 4 includes a raising operation of the boom 4A, a lowering operation of the boom 4A, a dumping operation of the arm 4B, an excavation operation of the arm 4B, an excavation operation of the bucket 4C, and a dumping operation of the bucket 4C.

The remote operation device 40 includes a left working lever 41 and a right working lever 42 operated for the operation of the swing body 3 and the working equipment 4, and a left traveling pedal 43 and a right traveling pedal 44 operated for the operation of the traveling body 2. The left working lever 41 is operated by the operator's left hand. The right working lever 42 is operated by the operator's right hand. The left traveling pedal 43 is operated by the operator's left foot. The right traveling pedal 44 is operated by the operator's right foot.

The left working lever 41 is disposed on the left side of the operation seat 45. The right working lever 42 is disposed on the right side of the operation seat 45. As an example, when the left working lever 41 is operated in the front-rear direction, the arm 4B performs a dumping operation or an excavation operation. When the left working lever 41 is operated in the left-right direction, the swing body 3 performs a left swing operation or a right swing operation. When the right working lever 42 is operated in the left-right direction, the bucket 4C performs an excavation operation or a dumping operation. When the right working lever 42 is operated in the front-rear direction, the boom 4A performs a lowering operation or a raising operation. Note that when the left working lever 41 is operated in the front-rear direction, the swing body 3 may perform the right swing operation or the left swing operation, and when the left working lever 41 is operated in the left-right direction, the arm 4B may perform the dumping operation or the excavation operation. The operation direction of the left working lever 41 and the operation direction of the right working lever 42 are arbitrarily related to the operation of the working equipment 4.

The left traveling pedal 43 and the right traveling pedal 44 are disposed on the front lower side of the operation seat 45. The left traveling pedal 43 is disposed to the left of the right traveling pedal 44. When the left traveling pedal 43 is operated, the crawler belt 2C on the left side of the traveling body 2 performs a forward operation or a backward operation. When the right traveling pedal 44 is operated, the crawler belt 2C on the right side of the traveling body 2 performs a forward operation or a backward operation.

In addition, in the remote operation room 200, a first monitor device 501 that displays work machine operation data indicating an operation status of the work machine 1 and an operation switch 502 that is operated to operate an electric device mounted on the work machine 1 are disposed. The first monitor device 501 displays, for example, a remaining amount of fuel of an engine mounted on the work machine 1, a temperature of coolant of the engine, a temperature of hydraulic oil for driving the hydraulic cylinder 5, and a traveling speed of the traveling body 2 as the work machine operation data. The operation switch 502 operates, for example, a headlight provided on the work machine 1 as an electric device mounted on the work machine 1.

The display device 50 displays the first image P1 and the second image P2 transmitted from the work machine 1. The first image P1 and the second image P2 are transmitted to the control device 60 of the remote operation system 100 via the control device 300 and the communication system 400. The control device 60 causes the display device 50 to display the first image P1 and the second image P2 acquired via the communication system 400. The display device 50 displays the second image P2 together with the first image P1. In the embodiment, the display device 50 displays the second image P2 so as to overlap a part of the first image P1.

The display device 50 includes a flat panel display such as a liquid crystal display (LCD) or an organic electroluminescence display (OELD). In the embodiment, the display device 50 includes a plurality of flat panel displays disposed adjacent to each other. In the embodiment, the display device 50 includes a central display 51, a left display 52 disposed on a left side of the central display 51, a right display 53 disposed on a right side of the central display 51, an upper display 54 disposed above the central display 51, and a lower display 55 disposed below the central display 51.

The first image P1 displayed on the display device 50 is an image corresponding to the field of view of the front space of the operator when the operator is assumed to be seated on the driver's seat provided in the driver's cab 3A of the work machine 1. The operator in the remote operation room 200 can obtain a feeling of actually sitting on the driver's seat of the work machine 1.

The operator in the remote operation room 200 operates the remote operation device 40 to operate the working equipment 4, and excavates the work target. The excavated object excavated by the bucket 4C of the working equipment 4 is loaded onto a dump truck as a load.

In the embodiment, the dump truck is an unmanned dump truck that travels based on a control command transmitted from a control facility of the work site. In the remote operation room 200, a second monitor device 503 that displays dump truck operation data indicating an operation status of the unmanned dump truck at the work site is disposed. In the unmanned dump truck, a position sensor that detects position data of the unmanned dump truck is disposed. The position sensor detects an absolute position of the unmanned dump truck using a global navigation satellite system (GNSS). The second monitor device 503 displays the position of each of a plurality of unmanned dump trucks operating at the work site as the dump truck operation data. In addition, the operator can stop or depart the unmanned dump truck by operating an input device provided in the second monitor device 503.

In addition, in the remote operation room 200, a third monitor device 504 that displays guidance data of the working equipment 4 is disposed. As the guidance data, a relative distance between the target design surface of the work target and the working equipment 4, a shape of the work target, and an ore distribution of the work target are exemplified.

### Control Device

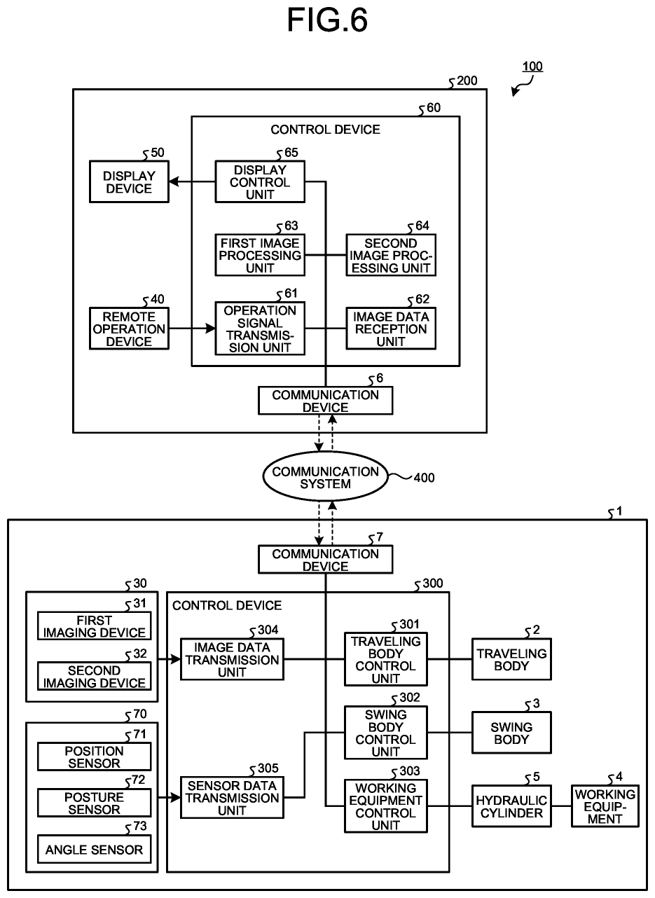

FIG. 6 is a functional block diagram illustrating the remote operation system 100 for the work machine 1 according to the embodiment. As illustrated in FIG. 6, the remote operation system 100 includes a communication device 6 disposed at a remote place, the control device 60 connected to the communication device 6, the remote operation device 40 connected to the control device 60, and the display device 50 connected to the control device 60. In addition, the remote operation system 100 includes a communication device 7 disposed in the work machine 1, the control device 300 connected to the communication device 7, the imaging device 30 connected to the control device 300, a sensor 70 connected to the control device 300, the traveling body 2 controlled by the control device 300, the swing body 3 controlled by the control device 300, and the hydraulic cylinder 5 controlled by the control device 300. The imaging device 30 includes the first imaging device 31 and the second imaging device 32. The sensor 70 includes a position sensor 71, a posture sensor 72, and an angle sensor 73.

The control device 300 includes a traveling body control unit 301, a swing body control unit 302, a working equipment control unit 303, an image data transmission unit 304, and a sensor data transmission unit 305.

The traveling body control unit 301 receives an operation signal of the remote operation device 40 transmitted from the control device 60. The traveling body control unit 301 outputs a control signal for controlling the operation of the traveling body 2 based on the operation signal of the remote operation device 40.

The swing body control unit 302 receives an operation signal of the remote operation device 40 transmitted from the control device 60. The swing body control unit 302 outputs a control signal for controlling the operation of the swing body 3 based on the operation signal of the remote operation device 40.

The working equipment control unit 303 receives an operation signal of the remote operation device 40 transmitted from the control device 60. The working equipment control unit 303 outputs a control signal for controlling the operation of the working equipment 4 based on the operation signal of the remote operation device 40. The control signal for controlling the working equipment 4 includes a control signal for controlling the hydraulic cylinder 5.

The image data transmission unit 304 transmits the image of the work site acquired by the imaging device 30 to the control device 60. The image data transmission unit 304 acquires the first image P1 of the first imaging range M1 from the first imaging device 31, and acquires the second image P2 of the second imaging range M2 from the second imaging device 32. The image data transmission unit 304 transmits the first image P1 and the second image P2 to the control device 60.

The sensor data transmission unit 305 transmits detection data of the sensor 70 mounted on the work machine 1 to the control device 60. In the embodiment, the sensor 70 includes the position sensor 71 that detects the position of the swing body 3, the posture sensor 72 that detects the posture of the swing body 3, and the angle sensor 73 that detects the angle of the working equipment 4. The position sensor 71 detects the absolute position of the swing body 3 using a global navigation satellite system (GNSS). The position sensor 71 includes a GNSS receiver provided in the swing body 3. The posture sensor 72 detects an inclination angle of the swing body 3 with respect to the horizontal plane. The posture sensor 72 includes an inertial measurement unit (IMU) provided in the swing body 3. The angle sensor 73 detects an angle of the working equipment 4. The angle sensor 73 includes a boom angle sensor that detects the angle of the boom 4A with respect to the swing body 3, an arm angle sensor that detects the angle of the arm 4B with respect to the boom 4A, and a bucket angle sensor that detects the angle of the bucket 4C with respect to the arm 4B.

The communication device 7 communicates with the communication device 6 via the communication system 400. The communication device 7 receives an operation signal of the remote operation device 40 transmitted from the control device 60 via the communication device 6, and outputs the operation signal to the control device 300. The communication device 7 transmits the first image P1 of the first imaging range M1 and the second image P2 of the second imaging range M2 received from the image data transmission unit 304 to the communication device 6 at the remote place. The communication device 7 includes an encoder that compresses the image data of the first image P1 and the image data of the second image P2. Each of the first image P1 and the second image P2 is transmitted from the communication device 7 to the communication device 6 in a compressed state.

The communication device 6 communicates with the communication device 7 via the communication system 400. The communication device 6 transmits an operation signal generated by operating the remote operation device 40 to the communication device 7. The communication device 6 receives the first image P1 and the second image P2 transmitted from the control device 300 via the communication device 7, and outputs the first image P1 and the second image P2 to the control device 60. The communication device 6 includes a decoder that restores the compressed image data of the first image P1 and the compressed image data of the second image P2. The first image P1 and the second image P2 are output from the communication device 6 to the control device 60 in a restored state.

The control device 60 includes an operation signal transmission unit 61, an image data reception unit 62, a first image processing unit 63, a second image processing unit 64, and a display control unit 65.

The operation signal transmission unit 61 transmits an operation signal for remotely operating the work machine 1. When the remote operation device 40 is operated by the operator, an operation signal for remotely operating the work machine 1 is generated. The operation signal transmission unit 61 transmits an operation signal of the remote operation device 40 to the control device 300.

The image data reception unit 62 receives the first image P1 and the second image P2. The image data reception unit 62 acquires the first image P1 and the second image P2 restored by the decoder of the communication device 6.

The first image processing unit 63 divides the first image P1 received by the image data reception unit 62.

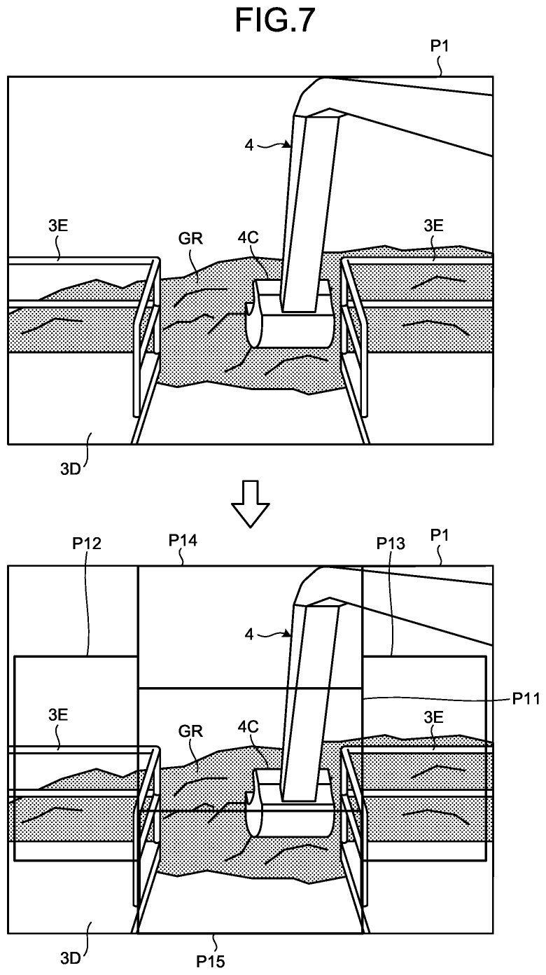

FIG. 7 is a diagram for describing processing of the first image processing unit 63 according to the embodiment. As illustrated in FIG. 7, the first image P1 is acquired by the image data reception unit 62. The first image P1 is an image of the front space SP1 of the swing body 3. A part of the working equipment 4 including the bucket 4C is shown in the first image P1. In addition, in the first image P1, a work target in front of the swing body 3 is shown. In addition, in the first image P1, the handrail 3E of the upper deck 3D is shown.

The first image processing unit 63 divides the first image P1 into a plurality of images. The first image processing unit 63 divides the first image P1 into an image P11 to be displayed on the central display 51, an image P12 to be displayed on the left display 52, an image P13 to be displayed on the right display 53, an image P14 to be displayed on the upper display 54, and an image P15 to be displayed on the lower display 55.

The second image processing unit 64 generates a superimposed image P2S from the second image P2 received by the image data reception unit 62.

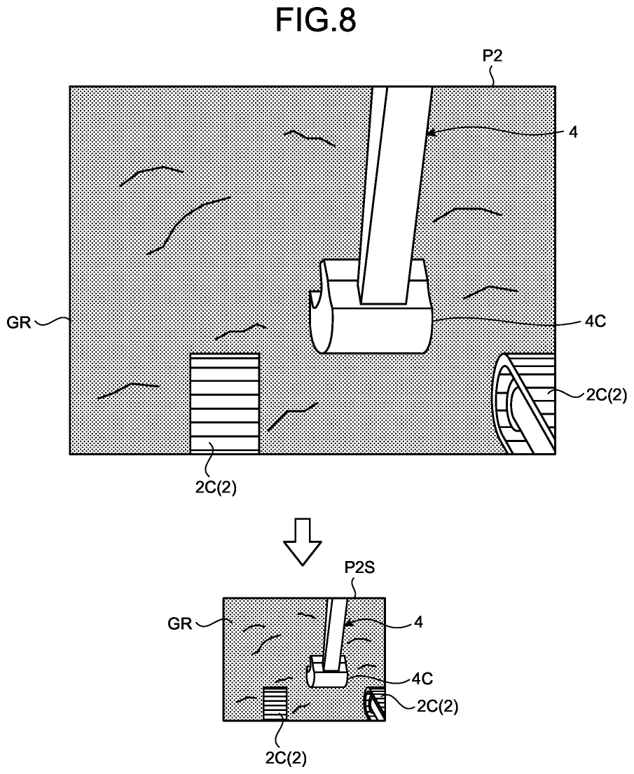

FIG. 8 is a diagram for describing processing of the second image processing unit 64 according to the embodiment. As illustrated in FIG. 8, the second image P2 is acquired by the image data reception unit 62. The second image P2 is an image of the front lower space SP2 of the driver's cab 3A. In the second image P2, the front portion of the crawler belt 2C of the traveling body 2 is shown. In addition, in the second image P2, a part of the working equipment 4 including the bucket 4C is shown. In addition, in the second image P2, a part of the ground GR on which the traveling body 2 travels is shown. The swing body 3 is not disposed in the second imaging range M2 of the second imaging device 32. The swing body 3 including the upper deck 3D and the handrail 3E is not shown in the second image P2.

The second image processing unit 64 reduces the second image P2 to generate the superimposed image P2S.

The display control unit 65 causes the display device 50 to display the first image P1 and the second image P2. The display control unit 65 causes the display device 50 to display the second image P2 together with the first image P1. In the embodiment, the display control unit 65 causes the display device 50 to display the second image P2 together with the first image P1 such that the second image P2 overlaps a part of the first image P1.

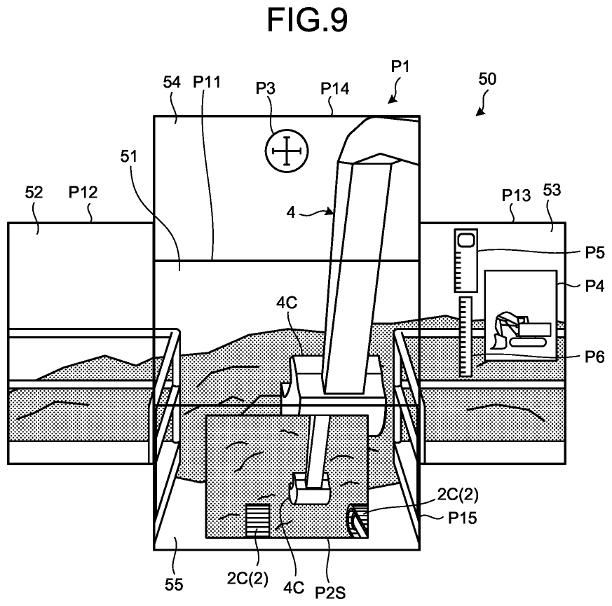

FIG. 9 is a diagram for describing processing of the display control unit 65 according to the embodiment. As illustrated in FIG. 9, the display control unit 65 causes the central display 51 to display the image P11 that is a part of the first image P1. The display control unit 65 causes the left display 52 to display the image P12 that is a part of the first image P1. The display control unit 65 causes the right display 53 to display the image P13 that is a part of the first image P1. The display control unit 65 causes the upper display 54 to display the image P14 that is a part of the first image P1. The display control unit 65 causes the lower display 55 to display the image P15 that is a part of the first image P1.

The display control unit 65 superimposes the superimposed image P2S generated from the second image P2 on the lower portion of the first image P1 and causes the display device 50 to display the superimposed image P2S. In the embodiment, the display control unit 65 superimposes the superimposed image P2S on the image P15 and causes the lower display 55 to display the superimposed image P2S.

Note that, in the embodiment, the display control unit 65 causes the display device 50 to display a vehicle body data image P3 indicating the posture of the swing body 3, a working equipment data image P4 indicating the posture of the working equipment 4, a load data image P5 indicating the weight of the load to be loaded onto the dump truck, and a bucket data image P6 indicating the position of the tip blade 4D of the bucket 4C.

The display control unit 65 calculates the inclination angle of the swing body 3 with respect to the horizontal plane based on the detection data of the posture sensor 72. The display control unit 65 causes the display device 50 to display a symbol image indicating the inclination angle of the swing body 3 as the vehicle body data image P3. In the embodiment, the vehicle body data image P3 is displayed on the upper display 54.

In addition, the display control unit 65 calculates the posture of the working equipment 4 based on the detection data of the angle sensor 73. The display control unit 65 causes the display device 50 to display an animation image indicating the posture of the working equipment 4 as the working equipment data image P4. In the embodiment, the working equipment data image P4 is displayed on the right display 53.

In addition, the display control unit 65 calculates the weight of the load to be loaded onto the dump truck based on detection data of a weight sensor (not illustrated) that detects the weight of the load held by the bucket 4C. The display control unit 65 causes the display device 50 to display an indicator image indicating the weight of the load as the load data image P5. In the embodiment, the load data image P5 is displayed on the right display 53.

In addition, the display control unit 65 calculates the position of the tip blade 4D of the bucket 4C in the vertical direction based on the detection data of the angle sensor 73. The display control unit 65 causes the display device 50 to display an indicator image indicating the position in the vertical direction of the tip blade 4D of the bucket 4C as the bucket data image P6. In the embodiment, the bucket data image P6 is displayed on the right display 53.

### Remote Operation Method

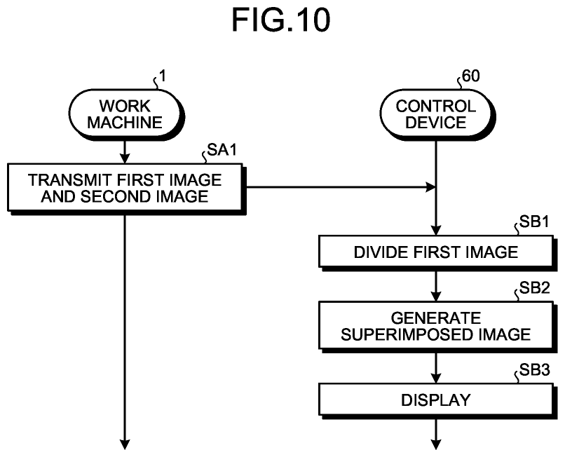

FIG. 10 is a flowchart illustrating a remote operation method of the work machine 1 according to the embodiment. Hereinafter, a method of processing the first image P1 and the second image P2 will be mainly described. Note that, as described above, when the remote operation device 40 is operated, an operation signal for remotely operating the work machine 1 is transmitted from the operation signal transmission unit 61 of the control device 60 to the control device 300.

The first imaging device 31 images the first imaging range M1 including the front space SP1 of the swing body 3. The second imaging device 32 images the second imaging range M2 including the front lower space SP2 of the swing body 3. The image data transmission unit 304 transmits the first image P1 and the second image P2 to the control device 60 via the communication device 7 and the communication system 400. Each of the first image P1 and the second image P2 is transmitted from the work machine 1 to the control device 60 in a compressed state (step SA1).

The image data reception unit 62 receives the first image P1 and the second image P2 transmitted from the work machine 1 via the communication device 6. The image data reception unit 62 receives the restored first image P1 and second image P2.

The first image processing unit 63 divides the first image P1 into the image P11, the image P12, the image P13, the image P14, and the image P15 (step SB1).

The second image processing unit 64 generates the superimposed image P2S from the second image P2 (step SB2).

Note that the processing of step SB2 may be performed before the processing of step SB1, or the processing of step SB1 and the processing of step SB2 may be performed in parallel.

The display control unit 65 causes the display device 50 to display the first image P1. The display control unit 65 displays the image P11 on the central display 51, the image P12 on the left display 52, the image P13 on the right display 53, the image P14 on the upper display 54, and the image P15 on the lower display 55.

In addition, the display control unit 65 superimposes the second image P2 on a part of the first image P1 displayed on the display device 50. That is, the display device 50 displays the second image P2 so as to overlap a part of the first image P1. The second image P2 is superimposed on the lower portion of the first image P1. The superimposed image P2S of the second image P2 is displayed so as to be superimposed on the image P15 on the lower display 55 (step SB3).

### Computer System

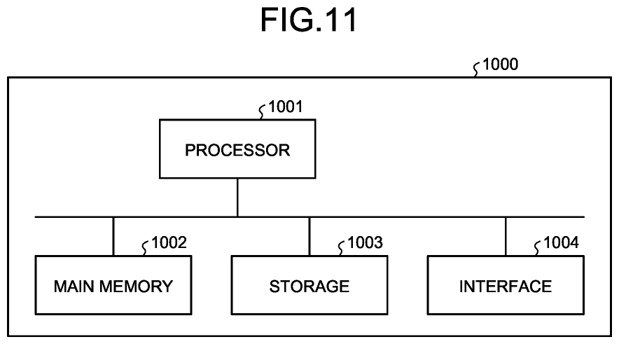

FIG. 11 is a block diagram illustrating a computer system 1000 according to the embodiment. Each of the control device 60 and the control device 300 described above includes the computer system 1000. The computer system 1000 includes a processor 1001 such as a central processing unit (CPU), a main memory 1002 including a nonvolatile memory such as a read only memory (ROM) and a volatile memory such as a random access memory (RAM), a storage 1003, and an interface 1004 including an input/output circuit. The function of the control device 60 and the function of the control device 300 described above are stored in the storage 1003 as a computer program. The processor 1001 reads the computer program from the storage 1003, develops the computer program in the main memory 1002, and executes the above-described processing according to the program. Note that the computer program may be distributed to the computer system 1000 via a network.

According to the above-described embodiment, the computer program or the computer system 1000 can execute: causing the first imaging device 31 disposed on the swing body 3 to image the first imaging range M1 to acquire the first image P1 of the first imaging range M1; causing the second imaging device 32 disposed on the swing body 3 to image the second imaging range M2 to acquire the second image P2 of the second imaging range M2; and causing the first image P1 and the second image P2 to be transmitted to the remote place.

### Effects

As described above, according to the embodiment, the first imaging device 31 and the second imaging device 32 are disposed on the swing body 3 of the work machine 1. The first imaging device 31 images the first imaging range M1. The first imaging range M1 is set in front of the swing body 3. At least a part of the working equipment 4 is disposed in the first imaging range M1. In addition, at least a part of the work target of the work machine 1 is disposed in the first imaging range M1. Therefore, the operator in the remote operation room 200 can perform the excavation work of the work target using the working equipment 4 while viewing the first image P1 of the first imaging range M1 displayed on the display device 50. The second imaging device 32 images the second imaging range M2. The second imaging range M2 is set on the front lower side of the swing body 3. At least a part of the second imaging range M2 of the second imaging device 32 is disposed below the first imaging range M1 of the first imaging device 31. Therefore, even if the first image P1 does not include the image of the front lower space SP2, the operator in the remote operation room 200 can check the situation of the front lower space SP2 by viewing the second image P2 of the second imaging range M2 displayed on the display device 50.

At least a part of the traveling body 2 can be disposed in the second imaging range M2. As a result, the operator in the remote operation room 200 can check the state of the traveling body 2 by viewing the second image P2 displayed on the display device 50.

The bucket 4C moved downward is disposed in the second imaging range M2. As a result, the operator in the remote operation room 200 can check the state of the bucket 4C moved to the lower portion of the movable range by viewing the second image P2 displayed on the display device 50. In addition, since the work target of the work machine 1 is disposed in the second imaging range M2, the operator in the remote operation room 200 can check the state of the work target by viewing the second image P2 displayed on the display device 50.

The first imaging range M1 is imaged by the first imaging device 31, and the second imaging range M2 is imaged by the second imaging device 32. When the work site is imaged by the first imaging device 31 and the second imaging device 32, an image of the work site is transmitted from the work machine 1 to the control device 60 in a state of being divided into the first image P1 and the second image P2. Therefore, each of the data amount of the first image P1 and the data amount of the second image P2 transmitted from the work machine 1 to the control device 60 is small. Since each of the data amount of the first image P1 and the data amount of the second image P2 is small, each of the time required to compress the image data, the time required to transmit the image data, and the time required to restore the image data is shortened. For example, in a case where an imaging device having an optical system with a wide angle of view in which both the front space SP1 and the front lower space SP2 are included in one imaging range is employed, there is a possibility that the data amount of the image becomes large. As a result, there is a possibility that the time required for compression, transmission, and restoration of the image data becomes long. According to the embodiment, a time required for compression, transmission, and restoration of image data is shortened. Therefore, the delay of the movement of the work machine 1 displayed on the display device 50 with respect to the actual movement of the work machine 1 is suppressed. Therefore, the operator in the remote operation room 200 can smoothly and accurately remotely operate the work machine 1 while viewing the first image P1 and the second image P2 displayed on the display device 50.

In addition, the image of the work site is transmitted from the work machine 1 to the control device 60 in a state of being divided into the first image P1 and the second image P2, whereby a wireless communication band for transmitting the first image P1 and the second image P2 can be secured.

The second imaging device 32 is disposed on the lower surface of the upper deck 3D. As a result, the swing body 3 including the upper deck 3D and the handrail 3E is not shown in the second imaging range M2. The second image P2 is an image including the traveling body 2, the working equipment 4, and the ground GR without including the swing body 3. Therefore, the operator in the remote operation room 200 can appropriately recognize the situation of the front lower space SP2 of the swing body 3 by viewing the second image P2 displayed on the display device 50.

The display device 50 displays the superimposed image P2S of the second image P2 so as to overlap the lower portion of the first image P1. As a result, the operator in the remote operation room 200 can appropriately recognize the situation of the front space SP1 and the situation of the front lower space SP2 by viewing each of the first image P1 and the second image P2.

### Other Embodiments

In the above-described embodiment, the second imaging device 32 is disposed below the first imaging device 31 in the vertical direction of the swing body 3. In the vertical direction of the swing body 3, the second imaging device 32 may be disposed above the first imaging device 31, or may be disposed at the same position as the first imaging device 31.

In the above-described embodiment, the first imaging device 31 is disposed at the same position as the second imaging device 32 in the left-right direction of the swing body 3. In the left-right direction of the swing body 3, the first imaging device 31 may be disposed on the left or right of the second imaging device 32.

In the above-described embodiment, the first imaging device 31 is disposed behind the second imaging device 32 in the front-rear direction of the swing body 3. In the front-rear direction of the swing body 3, the first imaging device 31 may be disposed in front of the second imaging device 32, or may be disposed at the same position as the second imaging device 32.

In the above-described embodiment, the first imaging device 31 and the second imaging device 32 may be disposed adjacent to each other in the vertical direction or the left-right direction, and may be disposed such that the angle of the optical axis OA1 of the first imaging device 31 is different from the angle of the optical axis OA2 of the second imaging device 32 in the vertical direction. In addition, the first imaging device 31 and the second imaging device 32 may be disposed adjacent to each other in the vertical direction or the left-right direction, and may be disposed such that the angle of the optical axis OA1 of the first imaging device 31 is different from the angle of the optical axis OA2 of the second imaging device 32 in the left-right direction.

In the above-described embodiment, the superimposed image P2S of the second image P2 is displayed so as to overlap the lower portion of the first image P1. The superimposed image P2S may be displayed so as to overlap the upper portion of the first image P1, may be displayed so as to overlap the left portion of the first image P1, or may be displayed so as to overlap the right portion of the first image P1.

In the above-described embodiment, the first image P1 and the second image P2 may not overlap each other. The first image P1 and the second image P2 may be displayed side by side on the display device 50.

In the above-described embodiment, the first imaging device 31 may be disposed outside the driver's cab 3A. The first imaging device 31 may be disposed on the swing body 3.

As described above, an unmanned dump truck may operate at a work site. The unmanned dump truck travels based on a control command transmitted from a control facility of the work site. In the above-described embodiment, the image captured by the imaging device 30 may be transmitted to the control facility of the work site and displayed on the display device installed in the control facility. The control facility is disposed at a remote place of the work machine 1. The manager of the work site present in the control facility can see the image captured by the imaging device 30.

In the above-described embodiment, the swing body 3 (vehicle body) includes the driver's cab 3A. The swing body 3 may not include the driver's cab 3A. In a case where the driver's cab 3A does not exist in the swing body 3, the first imaging device 31 is disposed at the front portion of the swing body 3.

In the above-described embodiment, the display device 50 includes the plurality of displays (51, 52, 53, 54, and 55). The display device 50 may include one display. In addition, the display may be a flat panel display or a curved panel display.

Note that, in the embodiment described above, the work machine 1 is a loading excavator. The work machine 1 may be a backhoe. In addition, in the embodiment described above, the work machine 1 includes the swing body 3 as the vehicle body, but the vehicle body of the work machine 1 may not be the swing body. The work machine 1 only needs to be a work machine having working equipment, and may be a bulldozer or a wheel loader.

### REFERENCE SIGNS LIST

1 WORK MACHINE

2 TRAVELING BODY

2A DRIVE WHEEL

2B DRIVEN WHEEL

2C CRAWLER BELT

3 SWING BODY (VEHICLE BODY)

3A DRIVER′S CAB

3B LOWER DECK

3C STEPS

3D UPPER DECK

3E HANDRAIL

3F LADDER

4 WORKING EQUIPMENT

4A BOOM

4B ARM

4C BUCKET

4D TIP BLADE

5 HYDRAULIC CYLINDER

5A BOOM CYLINDER

5B ARM CYLINDER

5C BUCKET CYLINDER

6 COMMUNICATION DEVICE

7 COMMUNICATION DEVICE

30 IMAGING DEVICE

31 FIRST IMAGING DEVICE

32 SECOND IMAGING DEVICE

40 REMOTE OPERATION DEVICE

41 LEFT WORKING LEVER

42 RIGHT WORKING LEVER

43 LEFT TRAVELING PEDAL

44 RIGHT TRAVELING PEDAL

45 OPERATION SEAT

50 DISPLAY DEVICE

51 CENTRAL DISPLAY

52 LEFT DISPLAY

53 RIGHT DISPLAY

54 UPPER DISPLAY

55 LOWER DISPLAY

60 CONTROL DEVICE

61 OPERATION SIGNAL TRANSMISSION UNIT

62 IMAGE DATA RECEPTION UNIT

63 FIRST IMAGE PROCESSING UNIT

64 SECOND IMAGE PROCESSING UNIT

65 DISPLAY CONTROL UNIT

70 SENSOR

71 POSITION SENSOR

72 POSTURE SENSOR

73 ANGLE SENSOR

100 REMOTE OPERATION SYSTEM

200 REMOTE OPERATION ROOM

300 CONTROL DEVICE

301 TRAVELING BODY CONTROL UNIT

302 SWING BODY CONTROL UNIT

303 WORKING EQUIPMENT CONTROL UNIT

304 IMAGE DATA TRANSMISSION UNIT

305 SENSOR DATA TRANSMISSION UNIT

400 COMMUNICATION SYSTEM

501 FIRST MONITOR DEVICE

502 OPERATION SWITCH

503 SECOND MONITOR DEVICE

504 THIRD MONITOR DEVICE

1000 COMPUTER SYSTEM

1001 PROCESSOR

1002 MAIN MEMORY

1003 STORAGE

1004 INTERFACE

AX BOOM ROTATION AXIS

BX ARM ROTATION AXIS

CX BUCKET ROTATION AXIS

GR GROUND

RX SWING AXIS

M1 FIRST IMAGING RANGE

M2 SECOND IMAGING RANGE

OA1 OPTICAL AXIS

OA2 OPTICAL AXIS

P1 FIRST IMAGE

P11 IMAGE

P12 IMAGE

P13 IMAGE

P14 IMAGE

P15 IMAGE

P2 SECOND IMAGE

P2S SUPERIMPOSED IMAGE

P3 VEHICLE BODY DATA IMAGE

P4 WORKING EQUIPMENT DATA IMAGE

P5 LOAD DATA IMAGE

P6 BUCKET DATA IMAGE

SP1 FRONT SPACE

SP2 FRONT LOWER SPACE

1. A work machine comprising:
a vehicle body;
a first imaging device that is disposed in the vehicle body and images a first imaging range;
a second imaging device that is disposed in the vehicle body and images a second imaging range; and
a communication device that transmits a first image in the first imaging range and a second image in the second imaging range to a remote place, wherein
at least a part of the second imaging range is set below the first imaging range.

2. The work machine according to claim 1, wherein
the first imaging range is set in front of the vehicle body, and
the second imaging range is set on a front lower side of the vehicle body.

3. The work machine according to claim 1, wherein
the second imaging device is disposed below the first imaging device.

4. The work machine according to claim 1, wherein
the first imaging device is disposed at a position same as a position of the second imaging device in a vehicle width direction of the vehicle body.

5. The work machine according to claim 1, wherein
the first imaging device is disposed behind the second imaging device.

6. The work machine according to claim 1, wherein
the vehicle body includes a swing body,
the work machine includes
a traveling body that is disposed below the swing body and supports the swing body in a swingable manner, and
working equipment attached to the swing body,
the first imaging range is set to include at least a part of the working equipment, and
the second imaging range is set to be able to include at least a part of the traveling body.

7. The work machine according to claim 6, wherein
the second imaging range is set to include a bucket of the working equipment moved downward.

8. The work machine according to claim 6, wherein
the second imaging range is set to include at least a part of a work target or a ground on which the traveling body travels.

9. The work machine according to claim 1, wherein
the vehicle body includes an upper deck, and
the second imaging device is disposed on the upper deck.

10. A remote operation system for a work machine, comprising
a display device that is disposed at the remote place and displays the first image and the second image transmitted from the work machine according to claim 1, wherein
the display device displays the second image together with the first image.

11. The remote operation system for the work machine according to claim 10, wherein
the display device displays the second image to overlap a part of the first image.

12. The remote operation system for the work machine according to claim 11, wherein
the display device displays the second image to overlap a lower portion of the first image.
